(19) United States
(12) Patent Application Publication
(10) Pub. No.: US 2015/0046169 A1
(43) Pub. Date: Feb. 12, 2015

(54) INFORMATION PROCESSING METHOD AND ELECTRONIC DEVICE

(71) Applicant: Lenovo (Beijing) Limited, Beijing (CN)

(72) Inventors: Zhenyi Yang, Beijing (CN); Ran Li, Beijing (CN); Yan Dai, Beijing (CN)

(73) Assignee: Lenovo (Beijing) Limited, Beijing (CN)

(21) Appl. No.: 14/227,777

(22) Filed: Mar. 27, 2014

(30) Foreign Application Priority Data
Aug. 8, 2013 (CN) 201310344565.7

(51) Int. Cl. G10L 17/22

(52) U.S. Cl. CPC G10L 17/22
USPC 704/275

(57) ABSTRACT

The present disclosure provides information processing methods and electronic devices in view of the problem in the conventional technology that accuracy of adjusting parameters via voice input is low. The information processing method is applied in an electronic device comprising an output unit. The method comprises: outputting, by the output unit, first data corresponding to a first application when the electronic device executes the first application; acquiring a first voice input that is inputted in a voice input approach; performing voice recognition on the first voice input to acquire a first operation instruction; controlling the output unit to output second data based on the first operation instruction, wherein a first parameter of the second data is different from that of the first data; and setting, based on the first operation instruction, a response unit in a first operation area on the electronic device as a first function response unit adjust the first parameter, wherein the input approach for the first operation area is different from the voice input approach.

### RELATED APPLICATION

This application claims the benefit of priority under 35 U.S.C. Section 119, to Chinese Patent Application Serial No. 201310344565.7, filed on Aug. 8, 2013, which application is incorporated herein by reference in its entirety.

### TECHNICAL FIELD

The present disclosure relates electronic technology, and in particular, to information processing methods and electronic devices.

### BACKGROUND

With development of computer technology, a growing number of electronic devices are used in people's daily lives, such as, smart phones, tablets, smart TVs, etc., which provide great convenience.

Let's take smart phones for example. Currently, a user-friendly interface is provided to meet increasing requirements of users. When an application developer develops an application, a number of controls for adjusting parameters are “hidden” in a form of multi-level menus to present the display interface of the application in a concise manner. For example, for a camera application, the number of icons set in a viewfinder is as less as possible in order not to block the image in the viewfinder with the menu icons. However, various controls for adjusting parameters, such as photograph mode, exposure value, focal length, flash brightness, etc., are provided in sub menus for icons in the viewfinder in a form of multi-level menus in order to provide better photograph effects. In this way, when the user adjusts the parameters, operations are troublesome and complex. In order to simplify the operations to adjust the parameters, the user usually adjusts the parameters through voice input. For example, when the user wants to increase the exposure value, the user may speak to the microphone of the smart phone “Brighter”. At this time, the smart phone recognizes the content of the user's voice input, and increases a sensitivity by a preset value, for example, from 100 to 200, according to a preset rule.

However, during the process of implementing technical solutions according to embodiments of the present disclosure, inventors of the present application realizes that there are the following technical problems in the above technology.

Based on the content of the user's voice input, the electronic device can only adjust a parameter by a preset value according to a preset rule. Therefore, if the adjusted value does not meet the user's requirement, for example, in the case where the user wants to adjust the sensitivity, the electronic device adjusts the sensitivity to 200 based on the user's voice input, but the user does not consider the adjusted sensitivity to be desired, then the user controls the electronic device to adjust the sensitivity to 300 through voice input again. However, the user actually wants to make a slight adjustment to the sensitivity based on the value of 200, for example, to 234. The second voice input that adjusts the sensitivity directly to 300 is not the user's expectation. Therefore, the adjustment via voice input in the electronic device can only change a parameter by some fixed values, but cannot accurately adjust the parameter to a value expected by the user. Therefore, there is a technical problem with such electronic device that accuracy for adjusting parameters through voice input is low, and user experience is poor.

### SUMMARY

The present disclosure provides methods and electronic devices for processing information to address the technical problem with the conventional technology that accuracy for adjusting parameters through voice input is low.

In an aspect, an information processing method is provided according to an embodiment of the present disclosure. The method is applied in an electronic device comprising an output unit. The method comprises: outputting, by the output unit, first data corresponding to a first application when the electronic device executes the first application; acquiring a first voice input that is input in a voice input approach; performing voice recognition on the first voice input to acquire a first operation instruction; controlling the output unit to output second data based on the first operation instruction, wherein a first parameter of the second data is different from that of the first data; setting, based on the first operation instruction, a response unit in a first operation area on the electronic device as a first function response unit configured to adjust the first parameter, wherein the input approach for the first operation area is different from the voice input approach.

Alternatively, after the output unit outputs the first data corresponding to the first application, the method further comprises: acquiring a second voice input that is input in the voice input approach, wherein the second voice input is different from the first voice input; performing voice recognition on the second voice input to acquire a second operation instruction; controlling the output unit to output third data based on the second operation instruction, wherein a second parameter of the third data is different from that of the first data; setting, based on the second operation instruction, a response unit in a second operation area on the electronic device as a second function response unit configured to adjust the second parameter, and the input approach for the second operation area is different from the voice input approach.

Alternatively, the operation areas are partial areas on the display unit of the electronic device, and the partial areas and an edge of the display unit overlap with each other.

Alternatively, before the response unit in the first operation area on the electronic device is set as the first function response unit, the method further comprises: determining, based on a state of the electronic device, the first operation area as a partial area corresponding to the state.

Alternatively, the state of the electronic device comprises a display direction of the display unit and/or a holding position of the electronic device held by the user.

Alternatively, when the first application is a camera application, and said outputting, by the output unit, the first data corresponding to the first application comprises displaying, through the display unit of the electronic device, the first data captured by an image capture apparatus of the electronic device.

In another aspect, an electronic device is provided according to another embodiment of the present disclosure. The electronic device comprises: an output unit configured to output first data corresponding to a first application when the electronic device executes the first application, and further configured to output second data, wherein a first parameter of the second data is different from that of the first data; a voice input unit configured to acquire a first voice input that is inputted in a voice input approach; a voice recognition unit configured to perform voice recognition on the first voice input to acquire a first operation instruction; a control unit configured to control the output unit to output the second data based on the first operation instruction, wherein a first parameter of the second data is different from that of the first data, and further configured to set a response unit in a first operation area on the electronic device as a first function response unit based on the first operation instruction, the first function response unit configured to adjust the first parameter, wherein the input approach for the first operation area is different from the voice input approach.

Alternatively, the voice input unit is further configured to acquire a second voice input that is inputted in the voice input approach, wherein the second voice input is different from the first voice input; the voice recognition unit is further configured to perform voice recognition on the second voice input to acquire a second operation instruction; the control unit is further configured to control the output unit to output third data based on the second operation instruction, wherein a second parameter of the third data is different from that of the first data; further configured to set a response unit in a second operation area on the electronic device as a second function response unit based on the second operation instruction, wherein the second function response unit is configured to adjust the second parameter, and the input approach for the second operation area is different from the voice input approach.

Alternatively, the operation areas are partial areas on the display unit of the electronic device, wherein the partial areas and an edge of the display unit overlap with each other.

Alternatively, the control unit is configured to: determine, based on a state of the electronic device, the first operation area as the partial area corresponding to the state before the response unit in the first operation area on the electronic device is set as the first function response unit.

Alternatively, the state of the electronic device comprises a display direction of the display unit and/or a holding position of the electronic device held by the user.

Alternatively, when the first application is a camera application, the output unit is configured to: display, through the display unit of the electronic device, the first data captured by an image capture apparatus of the electronic device.

The embodiments of the present disclosure provides one or more technical solutions having at least the following advantages.

1. When an electronic device executes a first application, an output unit of the electronic device outputs first data corresponding to the first application. Then, the electronic device acquires a first voice input that is inputted by a user in a voice input approach. After that, voice recognition is performed on the first voice input to acquire a first operation instruction. Next, based on the first operation instruction, the output unit is controlled to output second data. A first parameter of the second data is different from that of the first data. Based on the first operation instruction, a response unit in a first operation area on the electronic device is set as a first function response unit configured to adjust the first parameter. The input approach for the first operation area is different from the voice input approach. In other words, when the user adjusts the first parameter through voice input, in addition to adjusting the first data to the second data having a different first parameter based on the voice input, the electronic device further sets the response unit in the first operation area as the first function response unit for further accurate manual adjustment by the user. In this way, when the electronic device adjusts the parameter to be a value through voice input, it may provide a function response unit corresponding to the parameter so that the user may adjust the parameter manually and accurately to his or her expected value. This solves the technical problem that accuracy for adjusting parameters through voice input is low. The accuracy of parameter adjustment is improved, and better user experience is provided.

2. Because the operation area is a partial area on the display unit of the electronic device that is overlapped with an edge of the display unit, it is convenient for the user to operate on this operation area, and the user experience is improved.

3. Because the state of the electronic device is detected before the response unit in the first operation area is set, and then the operation area is determined, based on this state, to be the partial area on the edge of the display unit corresponding to this state, the electronic device may set the first operation area to be a partial area based on the display mode of the display unit or the holding position on the electronic device at which it is held by the user. It is thus convenient for the user to operate with a single hand without significant shaking of the electronic device, and the user experience is improved.

### BRIEF DESCRIPTION OF THE DRAWINGS

FIG. 1 is a flow chart of an information processing method according to an embodiment of the present disclosure;

FIG. 2 is a schematic diagram showing positions on the edge of a display unit according to an embodiment of the present disclosure;

FIG. 3 is a schematic diagram showing positions on an area of a display unit other than the edge according to an embodiment of the present disclosure;

FIGS. 4A and 4B are schematic diagrams showing a position of an operation area determined based on a display mode of a display unit according to an embodiment of the present disclosure;

FIGS. 5A and 5B are schematic diagrams showing a position of an operation area determined based on how the user holds the electronic device according to an embodiment of the present disclosure;

FIG. 6 is schematic diagram showing a position of an operation area determined based on both of how the user holds the electronic device and a display mode of the display unit according to an embodiment of the present disclosure; and

FIG. 7 is a schematic diagram showing a structure of an electronic device according to an embodiment of the present disclosure.

### DETAILED DESCRIPTION

Embodiments of the present application provides methods and electronic devices for processing information to address the technical problem of complex operations of an electronic device and low operation efficiency due to multi-level menus that have to be operated on a level-wise basis.

In order to address the above technical problem, the basic idea of solutions according to embodiments of the present application is as follows.

When an electronic device executes a first application, an output unit of the electronic device outputs first data corresponding to the first application. Then, the electronic device acquires a first voice input that is inputted by a user in a voice input approach. After that, voice recognition is performed on the first voice input to acquire a first operation instruction. Next, based on the first operation instruction, the output unit is controlled to output second data. A first parameter of the second data is different from that of the first data. Based on the first operation instruction, a response unit in a first operation area on the electronic device is set as a first function response unit configured to adjust the first parameter. The input approach for the first operation area is different from the voice input approach. In other words, when the user adjusts the first parameter through voice input, in addition to adjusting the first data to the second data having a different first parameter based on the voice input, the electronic device further sets the response unit in the first operation area as the first function response unit for further accurate manual adjustment by the user. In this way, when the electronic device adjusts the parameter to be a value through voice input, it may provide a function response unit corresponding to the parameter so that the user may adjust the parameter manually and accurately to his or her expected value. This solves the technical problem that accuracy for adjusting parameters through voice input is low. The accuracy of parameter adjustment is improved, and better user experience is provided.

Detailed explanation of the technical solutions of the present application will be given with reference to the drawings and specific embodiments. It is to be understood that the embodiments of the present disclosure and specific features of the embodiments are described for illustration purpose only, and not limitation. In the case where no conflict is present, the embodiments of the present disclosure and technical features therein may be combined with each other.

In an aspect, an information processing method is provided in an embodiment of the present disclosure. The method is applied in an electronic device. The electronic device may be smart phones, tablets, or smart TVs, etc. This electronic device comprises an output unit, such as, a touch panel, a touch screen, a speaker, or an earphone. At least a first application is installed in the electronic device. This application may be a desktop application, a camera application, a music playback application, or a network radio application, etc.

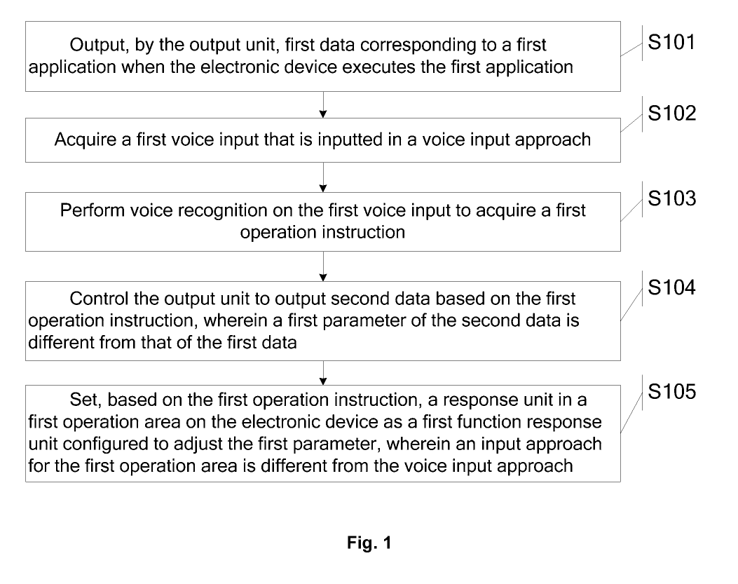

Please refer to FIG. 1, the information processing method comprises:

S101: outputting, by the output unit, first data corresponding to the first application when the electronic device executes the first application;

S102: acquiring a first voice input that is inputted in a voice input approach;

S103: performing voice recognition on the first voice input to acquire a first operation instruction;

S104: controlling the output unit to output second data based on the first operation instruction, wherein a first parameter of the second data is different from that of the first data;

S105: setting a response unit in a first operation area on the electronic device as a first function response unit based on the first operation instruction, the first function response unit being configured to adjust the first parameter, wherein the input approach for the first operation area is different from the voice input approach.

The above solution will be explained below by taking a camera application as an example of the first application.

After a user initiates the first application, i.e., the camera application, S101 is performed. In other words, when an electronic device executes the first application, the output unit outputs the first data corresponding to the first application.

In particular, the display unit of the electronic device displays first data captured by an image capture apparatus of the electronic device. In other words, when a first parameter of the image capture apparatus has a first value, the image capture apparatus captures the first data, and the first data is displayed on the display unit. For example, when the sensitivity of the image capture apparatus (e.g., a camera) is 100, the photosensitive element of the camera transmits image signals to ISP (Image Signal Processor), the image signals are processed to generate a frame of image, i.e. the first data, for display on the display unit.

In a specific implementation, S101 may varies with different first applications. For example, when the first application executed in the electronic device is a music playback application, the output unit, i.e., the speakers or earphones of the electronic device, outputs the audio data currently played by the music playback application; when the first application executed in the electronic device is a desktop application, the output unit, i.e., the display unit of the electronic device, outputs one of a plurality of desktop screens, for example, the first desktop screen. The first application may have many types, and accordingly the output unit and the first data outputted therefrom may also have many types. The present application is not limited in this aspect.

In practice, the first parameter may be brightness, color, color temperature, definition, exposure value, displayed content, video playback progress and the like of the display unit. The first parameter may also be volume for a sound output device, or audio playback progress, etc. The present application is not limited in this aspect.

It should be noted that the first application may run either in the foreground or in the background.

S102: acquiring a first voice input that is inputted in a voice input approach.

In the present embodiment, after the output unit (for example, the display unit of the electronic device) outputs the first data, the voice capture apparatus of the electronic device, such as, microphone, may acquire the first voice input by the user using the voice input approach. For example, the user may speak “Brighter”, “Closer”, etc., to the electronic device.

S103: performing voice recognition on the first voice input to acquire a first operation instruction.

In particular, the voice recognition is performed on the first voice input through a voice recognition unit on the electronic device to acquire the content of the first voice input. For example, if the first voice input is “Brighter”, the voice is recognized as “get brighter”. Then, according to correspondence between voice inputs and operation instructions, a first operation instruction corresponding to the first voice input is acquired, i.e., “Sensitivity Increase”.

In the present embodiment, the voice recognition on the first voice input may be performed in a “cloud” voice recognition method. In other words, the first voice input is “translated” into first semantic information by a voice recognition engine in the electronic device. Then, the first semantic information is transmitted to “cloud”, i.e., a server, and the server performs the semantic recognition based on the first semantic information to acquire the first operation instruction.

There are many other voice recognition methods for the first voice input, and not limited to the above two methods. The present application is not limited in this aspect.

S104: controlling the output unit to output second data based on the first operation instruction, wherein a first parameter of the second data is different from that of the first data.

In the present embodiment, after the first operation instruction is acquired at S103, the electronic device executes this instruction. According to a preset rule, the value of the first parameter is adjusted from a first value to a second value. The adjusted data is the second data. Then, the second data is outputted via the display unit. The term “preset rule” here specifies that the electronic device adjusts the first parameter based on the first operation instruction and an increment A for each adjustment is a fixed value, for example, Δ=+100, Δ=−100, etc. One skilled in the art may set the rule based on the practical applications, as long as the increment for each adjustment is a fixed value. The present application is not limited in this aspect.

For example, based on the first operation instruction, i.e. “Sensitivity Increase”, the value of the sensitivity is adjusted from 100 to 200 according to the preset rule stored in the electronic device. At this time, the photosensitive element transmits the acquired image signals to the ISP, and the ISP generates the second data indicating a sensitivity of 200. Then, the second data is displayed on the display unit. At this time, the user will see an image on the display unit that is brighter than that before the adjustment.

In the present embodiment, if the value of the first parameter of the second data does not meet the user's requirement after the adjustment of S104, the user may further adjust the value of the first parameter through voice input. For example, when the user inputs the first voice input to the electronic device, i.e. “Brighter”, the electronic device acquires the first operation instruction and executes it. Let's still take the sensitivity for example. According to the above preset rule, such as Δ=+100, the first parameter is adjusted from the second value to the third value, i.e. from 200 to 300. If the value after the adjustment still does not meet the user's requirement, the above S101-S104 may be repeated until the user's requirement is met.

In practice, after the adjustment of S104, the user may think that the adjusted second data goes beyond the user's expectation. For example, after the first parameter is adjusted to the second value, the user may think it is too bright. At this time, for the user's convenience, S105 may be performed while S104 is performed, so that the user may accurately adjust the second data to an expected value. While S104 is performed, S105 may be performed by setting, based on the first operation instruction, a response unit in a first operation area on the electronic device as a first function response unit configured to adjust the first parameter. The input approach for the first operation area is different from the voice input approach.

In particular, after the first operation instruction is acquired at S103, the response unit in the first operation area on the electronic device is set, based on this instruction, as the first function response unit configured to adjust the first parameter. For example, according to the first operation instruction, the response unit in the first operation area is set to be a sensitivity adjustment unit configured to adjust the sensitivity. In this way, the user may operate the first operation area in an input approach other than the voice input approach (such as sliding with a finger, clicking on a key, or rolling a wheel), so that the sensitivity adjustment unit may respond to the user's operation to further adjust the value of the sensitivity accurately.

In the present embodiment, the above first operation area may be configured in following two specific methods, but not limited thereto.

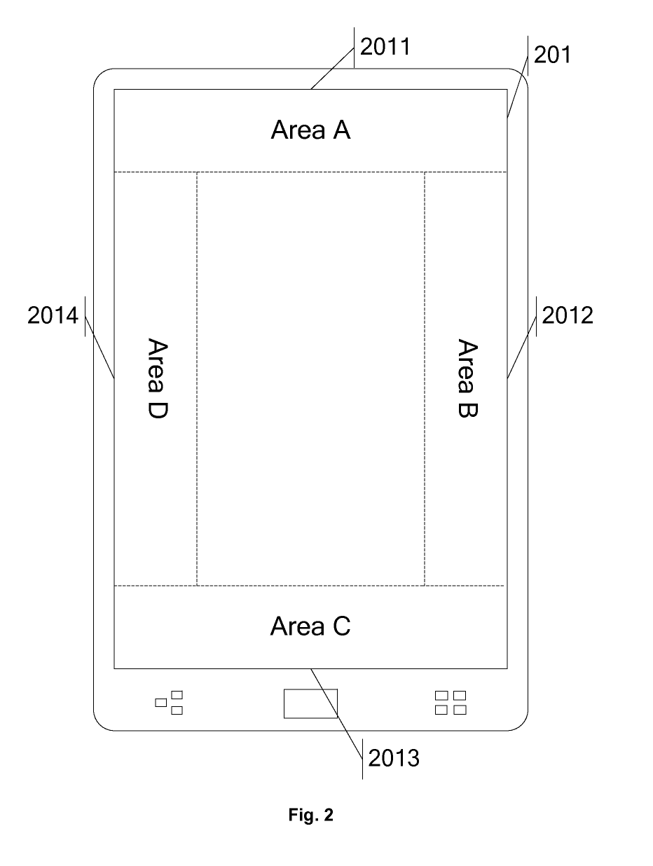

First method, the operation area is a partial area on the display unit of the electronic device, and the partial area and an edge of the display unit overlap. Please refer to FIG. 2, there are 4 areas on the display unit 201, Area A 2011, Area B 2012, Area C 2013, and Area D 2014. Each of these 4 areas is an edge of the display. The first operation area may be a partial area on the display unit that overlaps with one or more of the above 4 areas. In other words, the first operation area may be one or more of the above 4 areas. Preferably, in the case of the first specific method, the display unit 201 may be a touch screen. At this time, the first operation area may respond to the user's touch operation.

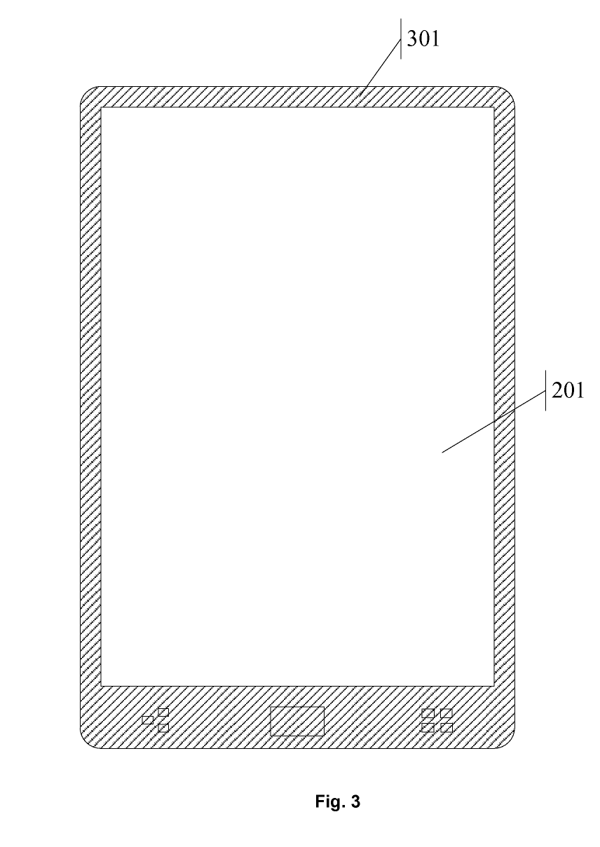

Second method, the first operation area may be one or more areas outside the display unit 201 on the electronic device, for example, the back plate of the electronic device, or one or more areas 301 other than the edges of the display unit as shown in FIG. 3. the first operation area may also be a volume key of the electronic device as long as the position of the first operation area is suitable for the user's operation with a single hand. The present application is not limited in this aspect. Preferably, in the case of the second specific method, the display unit 201 may be a general liquid crystal display (LCD) screen or a touch screen, and the first operation area may be a touch panel, a wheel, or a key provided on the backplate of the electronic device or the area 301 other than the edges.

In practice, the location of the first operation area and the specific configuration of the first operation area are not limited to the above several embodiments. The above one or more specific embodiments may be used for exemplifying the first operation area only, and one skilled in the art may set his/her own first operation area according to practical applications. The present application is not limited in this aspect.

In another embodiment, to facilitate the user's single-hand operation, it is necessary to further determine the location of the first operation area. Before the S105, the method further comprises: determining, based on a state of the electronic device, the first operation area as a partial area corresponding to the state.

In a specific implementation, the above state of the electronic device may include the following 3 cases but not limited thereto.

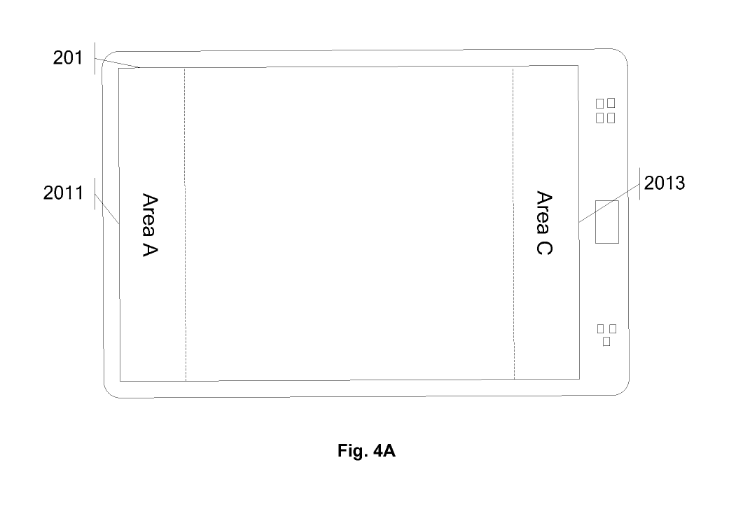

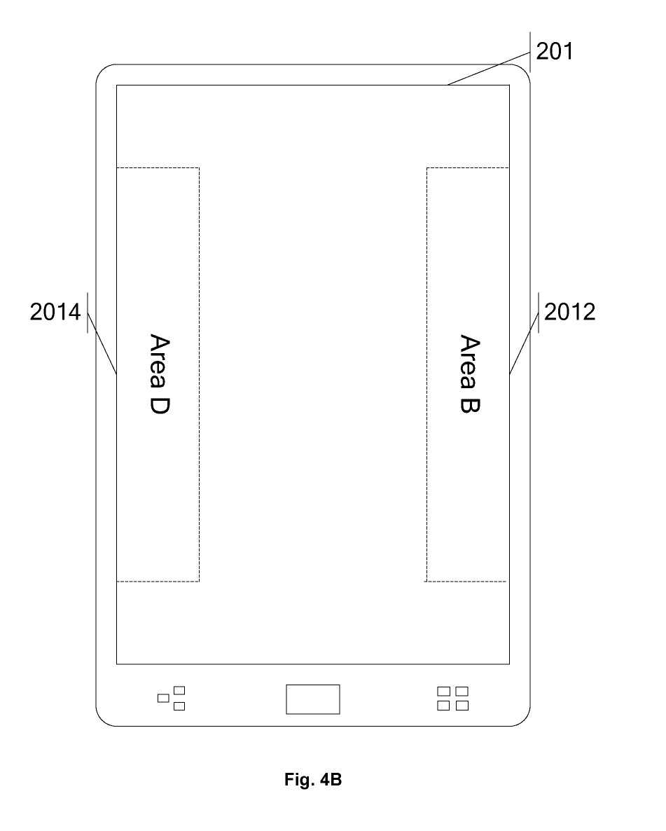

First, the state of the electronic device refers to a display direction of the display unit 201. For example, if the display mode of the display unit 201 is detected to be a landscape display mode, then the partial area corresponding to the landscape display mode is preferably determined as the first operation area, such as any of Area A 2011 or Area C 2013 shown in FIG. 4A. In another example, if the display mode of the display unit 201 is detected to be a portrait display mode, then the partial area corresponding to the portrait display mode is determined as the first operation area, such as any or both of Area B 2012 or Area D 2014 shown in FIG. 4B.

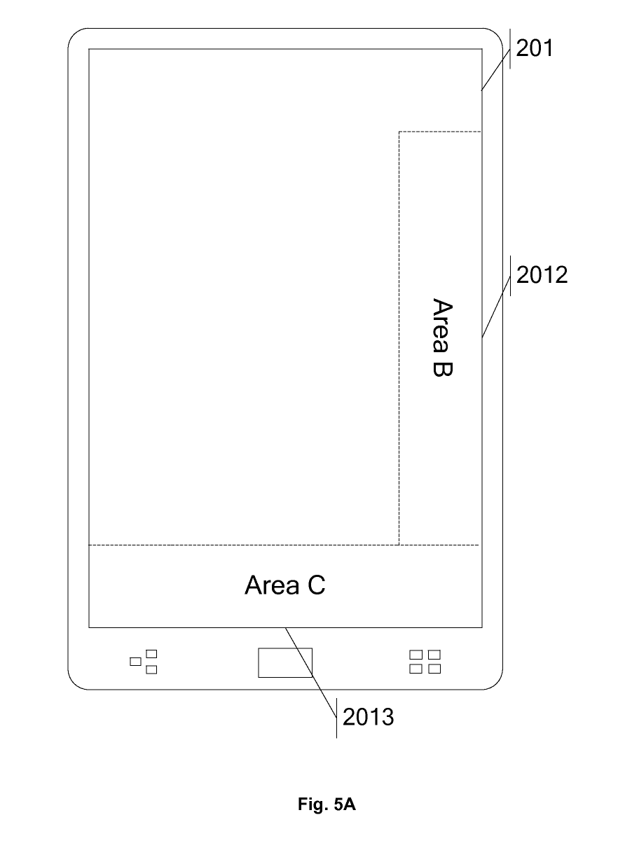

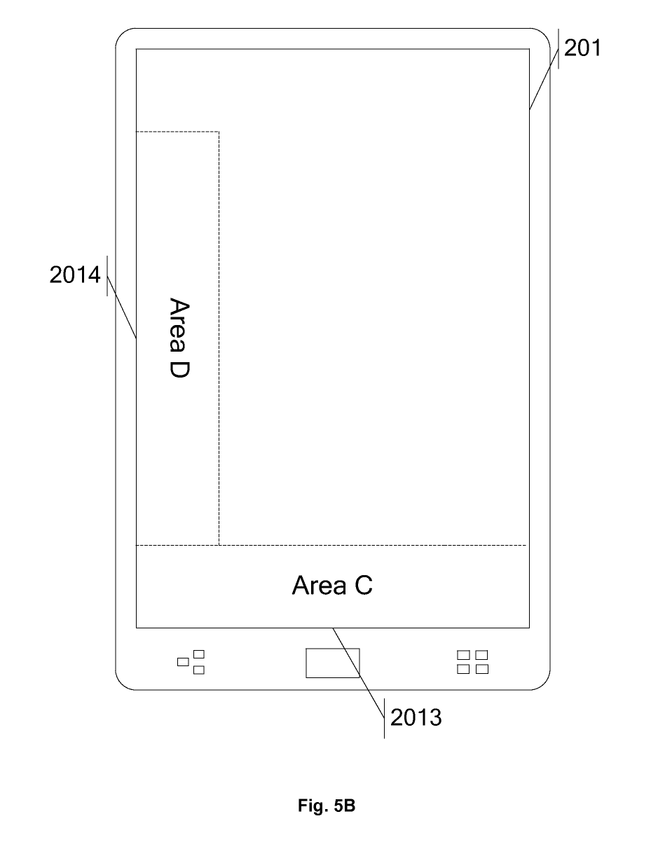

Second, the state of the electronic device refers to a holding position on the electronic device at which the electronic device is held by the user. For example, if it is detected that the electronic device is held by only the right hand of the user, the partial area corresponding to the single-hand holding position for the right hand is determined as the first operation area, such as any of Area B 2012 or Area C 2013 as shown in FIG. 5A. In another example, if it is detected that the electronic device is held by only the left hand of the user, the partial area corresponding to the single-hand holding position for the left hand is determined as the first operation area, such as any of Area D 2014 or Area C 2013 as shown in FIG. 5B.

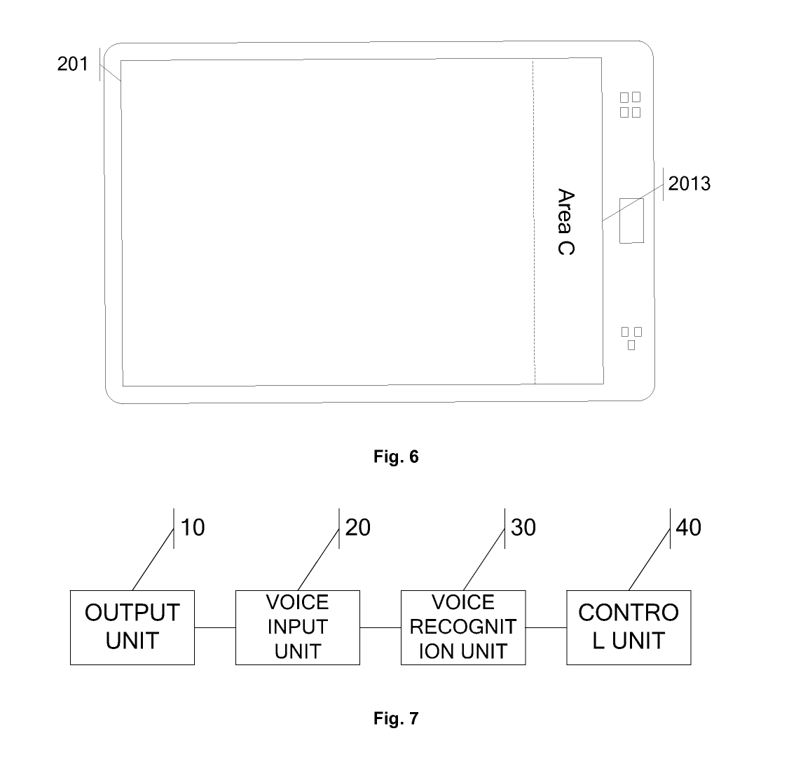

Third, the state of the electronic device refers to combination of the above first and second cases. In other words, the holding position of the electronic device held by the user and the display mode of the display unit 201 are detected simultaneously. For example, if it is detected that the electronic device is held by only the right hand of the user and the display unit 201 is in the landscape display mode, the partial area shown in FIG. 6 (i.e. Area C 2013) may be determined as the first operation area. The holding position of the electronic device held by the user and the display mode of the display unit 201 may be detected sequentially.

So far, the process of the electronic device adjusting the first parameter and setting the response unit in the first operation area as the first function response unit configured to adjust the first parameter based on the user's voice input have been completed.

In another embodiment, the electronic device may adjust different parameters based on different voice inputs. Then, after S101, the information processing method includes: acquiring a second voice input that is inputted in the voice input approach, wherein the second voice input is different from the first voice input; performing the voice recognition on the second voice input to acquire a second operation instruction; controlling the output unit to output third data based on the second operation instruction, wherein a second parameter of the third data is different from that of the first data; setting, based on the second operation instruction, the response unit in the second operation area on the electronic device as the second function response unit configured to adjust the second parameter, wherein the input approach of the second operation area is different from the voice input approach.

In the present embodiment, the above steps may be executed before or after S102, and the specific procedure is identical with S102-S105. Therefore, description thereof will be omitted for simplicity.

It should be noted that the second voice input is different from the first voice input. For example, the second voice input is “Closer”. At this time, voice recognition is performed on this voice input, and the second operation instruction, i.e. “Focal Length Increase”, is acquired based on the semantic meaning of the voice input. Then, based on the second operation instruction, the electronic device adjusts the value of the focal length from a first value to a second value according to a preset rule, for example, from 15 mm to 13 mm. At this time, the third data having a focal length parameter different from that of the first data is displayed on the display unit of the electronic device. Meanwhile, based on the second operation instruction, the electronic device sets the response unit in the second operation area on the electronic device as a focal length adjustment unit configured to adjust the value of the focal length, so that the user may adjust the second parameter, i.e. the value of the focal length, by manually operating on the second operation area.

In a specific implementation, the second operation area may be the same as the first operation area. It may be also set as an area different from the first operation area based on the state of the electronic device. For example, based on the state of the electronic device, i.e. if it is detected that the electronic device is held by only the right hand of the user, the display unit 201 is in the landscape display mode, and the first operation area is set to be Area C 2013, then the second area is set to be Area D 2014.

In the above description, when the electronic device executes a first application, an output unit of the electronic device outputs first data corresponding to the first application. Then, the electronic device acquires a first voice input that is inputted by a user in a voice input approach. After that, voice recognition is performed on the first voice input to acquire a first operation instruction. Next, based on the first operation instruction, the output unit is controlled to output second data. A first parameter of the second data is different from that of the first data. Based on the first operation instruction, a response unit in a first operation area on the electronic device is set as a first function response unit configured to adjust the first parameter. The input approach for the first operation area is different from the voice input approach. In other words, when the user adjusts the first parameter through voice input, in addition to adjusting the first data to the second data having a different first parameter based on the voice input, the electronic device further sets the response unit in the first operation area as the first function response unit for further accurate manual adjustment by the user. In this way, when the electronic device adjusts the parameter to be a value through voice input, it may provide a function response unit corresponding to the parameter so that the user may adjust the parameter manually and accurately to his or her expected value. This solves the technical problem that accuracy for adjusting parameters through voice input is low. The accuracy of parameter adjustment is improved, and better user experience is provided. Because the operation area is a partial area of the display unit of the electronic device that is overlapped with an edge of the display unit, it is convenient for the user to operate on this operation area, and the user experience is improved. Because the state of the electronic device is detected before the response unit in the first operation area is set, and then the operation area is determined, based on this state, to be the partial area on the edge of the display unit corresponding to this state, the electronic device may set the first operation area to be a partial area based on the display mode of the display unit or the holding position on the electronic device at which it is held by the user. It is thus convenient for the user to operate with a single hand without significant shaking of the electronic device, and the user experience is improved.

In another aspect, an electronic device is provided according to another embodiment of the present disclosure. The electronic device may be a smart phone, a tablet, or a smart TV, etc. As shown in FIG. 7, the electronic device includes: an output unit 10 configured to output first data corresponding to a first application when the electronic device executes the first application, and further configured to output second data, wherein a first parameter of the second data is different from that of the first data; a voice input unit 20 configured to acquire a first voice input that is inputted in a voice input approach; a voice recognition unit 30 configured to perform voice recognition on the first voice input to acquire a first operation instruction; a control unit 40 configured to control the output unit 10 to output the second data based on the first operation instruction, wherein a first parameter of the second data is different from that of the first data, and further configured to set, based on the first operation instruction, a response unit in a first operation area on the electronic device as a first function response unit configured to adjust the first parameter, wherein the input approach for the first operation area is different from the voice input approach.

In the present embodiment, the output unit 10 may be a touch panel, a touch screen, a speaker, or an earphone. At least a first application is installed in the electronic device. This application may be a desktop application, a camera application, a music playback application, or a network radio application, etc.

Alternatively, in the present embodiment, when the first application is a camera application, the output unit is configured to display, on the display unit of the electronic device, the first data captured by the image capture apparatus of the electronic device.

In the present embodiment, in addition to voice recognition performed on the first voice input by the local voice recognition unit 30, the voice recognition of the first voice input may be also performed in a “cloud” voice recognition method. In other words, the first voice input is “translated” into first semantic information by the voice recognition unit 30 on the electronic device. Then, the first semantic information is transmitted to “cloud”, i.e. a server, and the server performs semantic recognition based on the first semantic information to acquire the first operation instruction. There are many other methods for performing voice recognition of the first voice input, and not limited to the above two. The present application is not limited in this aspect.

Further, the operation area is a partial area on the display unit of the electronic device, and the partial area and the edge of the display unit overlap with each other.

In the present embodiment, the above first operation area may be configured in following two specific methods, but not limited thereto.

First method, the operation area is a partial area on the display unit of the electronic device, and the partial area and an edge of the display unit overlap. Please refer to FIG. 2, there are 4 areas on the display unit 201, Area A 2011, Area B 2012, Area C 2013, and Area D 2014. Each of these 4 areas is an edge of the display. The first operation area may be a partial area on the display unit that overlaps with one or more of the above 4 areas. In other words, the first operation area may be one or more of the above 4 areas. Preferably, in the case of the first specific method, the display unit 201 may be a touch screen. At this time, the first operation area may respond to the user's touch operation.

Second method, the first operation area may be one or more areas outside the display unit 201 on the electronic device, for example, the back plate of the electronic device, or one or more areas 301 other than the edges of the display unit as shown in FIG. 3. the first operation area may also be a volume key of the electronic device as long as the position of the first operation area is suitable for the user's operation with a single hand. The present application is not limited in this aspect. Preferably, in the case of the second specific method, the display unit 201 may be a general liquid crystal display (LCD) screen or a touch screen, and the first operation area may be a touch panel, a wheel, or a key provided on the backplate of the electronic device or the area 301 other than the edges.

In practice, the location of the first operation area and the specific configuration of the first operation area are not limited to the above several embodiments. The above one or more specific embodiments may be used for exemplifying the first operation area only, and one skilled in the art may set his/her own first operation area according to practical applications. The present application is not limited in this aspect.

Further, to facilitate the user's single-hand operation, the location of the first operation area needs to be further determined. The control unit 40 is configured to, before the response unit in the first operation area on the electronic device is set as the first function response unit, determine, based on the state of the electronic device, the first operation area as a partial area corresponding to the state. Preferably, the above state of the electronic device may refer to a display direction of the display unit and/or the holding position of the electronic device held by the user.

In a specific implementation, the above state of the electronic device may include the following 3 cases but not limited thereto.

First, the state of the electronic device refers to a display direction of the display unit 201. For example, if the display mode of the display unit 201 is detected to be a landscape display mode, then the partial area corresponding to the landscape display mode is preferably determined as the first operation area, such as any of Area A 2011 or Area C 2013 shown in FIG. 4A. In another example, if the display mode of the display unit 201 is detected to be a portrait display mode, then the partial area corresponding to the portrait display mode is determined as the first operation area, such as any or both of Area B 2012 or Area D 2014 shown in FIG. 4B.

Second, the state of the electronic device refers to a holding position on the electronic device at which the electronic device is held by the user. For example, if it is detected that the electronic device is held by only the right hand of the user, the partial area corresponding to the single-hand holding position for the right hand is determined as the first operation area, such as any of Area B 2012 or Area C 2013 as shown in FIG. 5A. In another example, if it is detected that the electronic device is held by only the left hand of the user, the partial area corresponding to the single-hand holding position for the left hand is determined as the first operation area, such as any of Area D 2014 or Area C 2013 as shown in FIG. 5B.

Third, the state of the electronic device refers to combination of the above first and second cases. In other words, the holding position of the electronic device held by the user and the display mode of the display unit 201 are detected simultaneously. For example, if it is detected that the electronic device is held by only the right hand of the user and the display unit 201 is in the landscape display mode, the partial area shown in FIG. 6 (i.e. Area C 2013) may be determined as the first operation area. The holding position of the electronic device held by the user and the display mode of the display unit 201 may be detected sequentially.

In another embodiment, the electronic device may adjust different parameters based on different voice inputs. Then, the voice input unit 20 is further configured to acquire a second voice input that is inputted in the voice input approach, wherein the second voice input is different from the first voice input; the voice recognition unit 30 is further configured to perform the voice recognition on the second voice input to acquire a second operation instruction; the control unit 40 is further configured to control the output unit 10 to output third data based on the second operation instruction, wherein a second parameter of the third data is different from that of the first data; the control unit 40 is further configured to set the response unit in the second operation area on the electronic device as the second function response unit based on the second operation instruction, wherein the second function response unit is configured to adjust the second parameter, and the input approach of the second operation area is different from the voice input approach.

In a specific implementation, the second operation area may be the same area as the first operation area. It may be also set as an area different from the first operation area based on the state of the electronic device. For example, based on the state of the electronic device, i.e. if it is detected that the electronic device is held by only the right hand of the user, the display unit 201 is in the landscape display mode, and the first operation area is set to be Area C 2013, the second area is set to be Area D 2014.

Various variants and examples of the information processing methods according to the above embodiments may be applicable to the electronic device of the present embodiment. From the above detailed description of the information processing method, one skilled in the art will know how to implement the electronic device of the present embodiment. Therefore, description thereof is omitted for simplicity.

The above technical solutions according to the embodiments of the present disclosure have at least the following advantages.

1. When an electronic device executes a first application, an output unit of the electronic device outputs first data corresponding to the first application. Then, the electronic device acquires a first voice input that is inputted by a user in a voice input approach. After that, voice recognition is performed on the first voice input to acquire a first operation instruction. Next, based on the first operation instruction, the output unit is controlled to output second data. A first parameter of the second data is different from that of the first data. Based on the first operation instruction, a response unit in a first operation area on the electronic device is set as a first function response unit configured to adjust the first parameter. The input approach for the first operation area is different from the voice input approach. In other words, when the user adjusts the first parameter through voice input, in addition to adjusting the first data to the second data having a different first parameter based on the voice input, the electronic device further sets the response unit in the first operation area as the first function response unit for further accurate manual adjustment by the user. In this way, when the electronic device adjusts the parameter to be a value through voice input, it may provide a function response unit corresponding to the parameter so that the user may adjust the parameter manually and accurately to his or her expected value. This solves the technical problem that accuracy for adjusting parameters through voice input is low. The accuracy of parameter adjustment is improved, and better user experience is provided.

2. Because the operation area is a partial area of the display unit of the electronic device that is overlapped with an edge of the display unit, it is convenient for the user to operate on this operation area, and the user experience is improved.

3. Because the state of the electronic device is detected before the response unit in the first operation area is set, and then the operation area is determined, based on this state, to be the partial area on the edge of the display unit corresponding to this state, the electronic device may set the first operation area to be a partial area based on the display mode of the display unit or the holding position on the electronic device at which it is held by the user. It is thus convenient for the user to operate with a single hand without significant shaking of the electronic device, and the user experience is improved.

It should be appreciated that the embodiments of the present disclosure may be provided as methods, systems, or computer programs. Therefore, the present disclosure may be implemented in hardware, software, or combination thereof. Further, the present disclosure may be implemented as a computer program product embodied on one or more computer-readable storage media (including but not limited to disk storage device, CD-ROM, optical storage device, etc.) having computer-readable program codes therein.

The present disclosure is described with reference to flow charts and/or block diagrams of the methods, devices (systems), and computer program products. It is to be understood that any flow and/or block in the flow charts and/or block diagrams and any combination of flow and/or block in the flow charts and/or block diagrams may be implemented by computer program instructions. These computer program instructions may be provided to processors of general purpose computers, special purpose computers, embedded processors or any other programmable data processing devices to form a machine such that means having functions specified in one or more flows in the flow charts and/or one or more blocks in the block diagrams can be implemented by instructions executed by processors of the computers or any other programmable data processing devices.

The computer program instructions may also be stored in computer readable memories which may guide the computers or any other programmable data processing devices to function in such a manner that the instructions stored in these computer readable memories may generate manufactures comprising instruction means, the instruction means implementing functions specified in one or more flows in the flow charts and/or one or more blocks in the block diagrams.

These computer program instruction may also loaded to computers or any other programmable data processing devices such that a series of operation steps are performed on the computers or any other programmable devices to generate processing implemented by the computers. Therefore, the instructions executed on the computers or any other programmable devices provide steps for implementing functions specified in one or more flows in the flow charts and/or one or more blocks in the block diagrams.

It is obvious that one skilled in the art may make various modifications and variants to the present disclosure without departing from the spirit and scope of the present disclosure. In this way, if these modifications and variants of the present disclosure belong to the scope of the claims of the present disclosure and its full scope equivalents, the present disclosure is intended to embrace these modifications and variants.

We claim:

1. An information processing method in an electronic device comprising an output unit, the method comprising:
outputting, by the output unit, first data corresponding to a first application when the electronic device executes the first application;
acquiring a first voice input that is inputted in a voice input approach;
performing voice recognition on the first voice input to acquire a first operation instruction;
controlling the output unit to output second data based on the first operation instruction, wherein a first parameter of the second data is different from that of the first data; and
setting, based on the first operation instruction, a response unit in a first operation area on the electronic device as a first function response unit configured to adjust the first parameter, wherein an input approach for the first operation area is different from the voice input approach.

2. The method according to claim 1, wherein, after outputting, by the output unit, the first data corresponding to the first application, the method further comprises:
acquiring a second voice input that is inputted in the voice input approach, wherein the second voice input is different from the first voice input;
performing voice recognition on the second voice input to acquire a second operation instruction;
controlling the output unit to output a third data based on the second operation instruction, wherein a second parameter of the third data is different from that of the first data; and
setting, based on the second operation instruction, a response unit in a second operation area on the electronic device as a second function response unit configured to adjust the second parameter, wherein an input approach for the second operation area is different from the voice input approach.

3. The method according to claim 1, wherein the first operation area is a partial area on the display unit of the electronic device, wherein the partial area and an edge of the display unit overlap.

4. The method according to claim 3, wherein, before setting the response unit in the first operation area on the electronic device as the first function response unit, the method further comprises:
determining, based on a state of the electronic device, the first operation area as the partial area corresponding to the state.

5. The method according to claim 4, wherein the state of the electronic device comprises a display direction of the display unit and/or a holding position on the electronic device at which the electronic device is held by the user.

6. The method according to claim 1, wherein, when the first application is a camera application, said outputting, by the output unit, the first data corresponding to the first application comprises displaying, by the display unit of the electronic device, the first data captured by an image capture apparatus of the electronic device.

7. An electronic device comprising:
an output unit configured to output first data corresponding to a first application when the electronic device executes the first application, and further configured to output a second data, wherein a first parameter of the second data is different from that of the first data;
a voice input unit configured to acquire a first voice input that is inputted in a voice input approach;
a voice recognition unit configured to perform voice recognition on the first voice input to acquire a first operation instruction; and
a control unit configured to control the output unit to output the second data based on the first operation instruction, wherein a first parameter of the second data is different from that of the first data, and further configured to set, based on the first operation instruction, a response unit in a first operation area on the electronic device as a first function response unit configured to adjust the first parameter, wherein an input approach for the first operation area is different from the voice input approach.

8. The electronic device according to claim 7, wherein the voice input unit is further configured to acquire a second voice input that is inputted in the voice input approach, wherein the second voice input is different from the first voice input;
the voice recognition unit is further configured to perform voice recognition on the second voice input to acquire a second operation instruction;
the control unit is further configured to control the output unit to output third data based on the second operation instruction, wherein a second parameter of the third data is different from that of the first data; further configured to set, based on the second operation instruction, a response unit in a second operation area on the electronic device as a second function response unit configured to adjust the second parameter, and the input approach for the second operation area is different from the voice input approach.

9. The electronic device according to claim 7, wherein the operation area is a partial area on the display unit of the electronic device, wherein the partial area and an edge of the display unit overlap.

10. The electronic device according to claim 9, wherein the control unit is configured to determine, based on a state of the electronic device, the first operation area as the partial area corresponding to the state, before the response unit in the first operation area on the electronic device is set as the first function response unit.

11. The electronic device according to claim 10, wherein the state of the electronic device comprises a display direction of the display unit and/or a holding position on the electronic device at which the electronic device is held by the user.

12. The electronic device according to claim 7, wherein, when the first application is a camera application, the output unit is configured to display, through the display unit of the electronic device, the first data captured by an image capture apparatus of the electronic device.
